(19) United States
(12) Patent Application Publication
(10) Pub. No.: US 2015/0069246 A1
(43) Pub. Date: Mar. 12, 2015

(54) INFORMATION OBTAINING APPARATUS AND INFORMATION OBTAINING METHOD

(71) Applicant: CANON KABUSHIKI KAISHA, Tokyo (JP)

(72) Inventor: Takeaki Itsuji, Hiratsuka-shi (JP)

(21) Appl. No.: 14/481,185

(22) Filed: Sep. 9, 2014

(30) Foreign Application Priority Data
Sep. 12, 2013 (JP) 2013-189445

(51) Int. Cl. G01N 21/55; G21K 5/02; G01J 1/04; G01N 21/59; G01J 1/42

(52) U.S. Cl. CPC G01N 21/55; G01N 21/59; G01J 1/42; G01J 1/0425; G21K 5/02; G01N 2201/06113; G01N 2201/0697; G01N 2201/08
USPC 250/341.2; 250/349

(57) ABSTRACT

An information obtaining apparatus includes a splitting unit, a terahertz wave generation unit, a terahertz wave detection unit, a fiber, a changing unit that changes an optical path length difference between optical path lengths of pump light and probe light by changing an optical path length of the fiber, a waveform construction unit, and an obtaining unit that obtains information related to the optical path length of the fiber. The obtaining unit includes a splitting unit that splits the pump or probe light before propagating through the fiber into first light and second light, a formation unit that forms interfering light, and an optical detection unit that detects an intensity of the interfering light. The waveform construction unit constructs a terahertz wave time waveform by extracting a detection result of the terahertz wave detection unit based on a detection result of the optical detection unit.

### BACKGROUND OF THE INVENTION

1. Field of the Invention

The present invention relates to an information obtaining apparatus that obtains information of a sample by using a terahertz wave and an information obtaining method.

2. Description of the Related Art

A terahertz wave is an electromagnetic wave typically having a component at an arbitrary frequency band in a range between 0.03 THz and 30 THz. As an inspection apparatus using this terahertz wave, an information obtaining apparatus configured to obtain information of a sample by adapting a terahertz time domain spectroscopy (THz-TDS) technique has been proposed.

This THz-TDS technique is a method of obtaining a time waveform of the terahertz wave by relatively changing timings at which pulse light (probe light) for detecting the terahertz wave and a pulsed terahertz wave reach a terahertz wave detection unit. At this time, detection timings are changed by changing an optical path length in which the probe light reaches the terahertz wave detection unit from a light source or an optical path length in which pulse light (pump light) for generating a terahertz wave reaches a terahertz wave generation unit from the light source by using a retardation optical unit.

A time obtain the time waveform depends on a sweeping speed of the retardation optical unit. In view of the above, to shorten the time obtain the time waveform, a technique with which a fiber-type retardation optical unit is constituted by using fiber wound around a piezoelectric element is described in Proc. of SPIE, 7485, 748504 (2009), Handheld terahertz spectrometer for the detection of liquid explosives (hereinafter, referred to as Non-patent document 1). In the fiber-type retardation optical unit, the optical path length of the fiber is changed by changing a length of the fiber or applying an electric field to the fiber to change a refractive index.

The optical path length of the fiber may be changed in some cases due to factors including a change in a surrounding environment (such as a temperature or a moisture) of the information obtaining apparatus, a change in an elasticity modulus of the fiber caused by repetition of fiber extension and retraction, and the like. In a case where fiber extension and retraction are caused by using the piezoelectric element, the optical path length may be varied even when control signals are the same due to an influence from hysteresis of the piezoelectric element. These situations occur because of a change in a propagation speed or a propagation distance of light that propagates through the fiber.

For that reason, even when the retardation optical unit is controlled in the same manner, the optical path length of the fiber is varied, and the terahertz wave detection may not be performed at a constant interval in some cases. According to Non-patent document 1, interfering light of the pulse light that has propagated through the fiber and reference light is detected, and the interval for the terahertz wave detection is stabilized from an intensity change pattern of the interfering light.

The change in the propagation speed or the propagation distance of the light that propagates through the fiber also affects the timing for starting the terahertz wave detection. For that reason, even when the detection interval is stabilized by the method described in Non-patent document 1, the time waveform of the terahertz wave may start from a different timing. That is, in a case where a plurality of time waveforms are obtained, positions on time axes of the respective time waveforms constructed by the information obtaining apparatus may be varied.

To suppress the influence of this positional variation, the same sample is measured plural times, and those results are averaged to extract the time waveform having the highest appearance probability according to Non-patent document 1. For that reason, the number of measurements performed for one sample is high, and it may take long time to obtain the time waveform.

### SUMMARY OF THE INVENTION

According to an aspect of the present invention, an information obtaining apparatus that irradiates a sample with a terahertz wave and obtains information of the sample includes a splitting unit that splits pulse light from a light source into pump light and probe light, a terahertz wave generation unit configured to generate a terahertz wave upon incidence of the pump light, a terahertz wave detection unit configured to detect the terahertz wave from the sample upon incidence of the probe light, a fiber through which the pump light or the probe light propagates, a changing unit configured to change an optical path length difference between an optical path length of the pump light and an optical path length of the probe light by changing an optical path length of the fiber, a waveform construction unit configured to construct a time waveform of the terahertz wave by using a detection result of the terahertz wave detection unit, and an obtaining unit configured to obtain information related to the optical path length of the fiber, wherein the obtaining unit includes a splitting unit that splits the pump light or the probe light before propagating through the fiber into first light and second light, a formation unit configured to form interfering light of the first light that has propagated through the fiber and the second light that has not propagated through the fiber, and an optical detection unit configured to detect an intensity of the interfering light as the information related to the optical path length of the fiber, and wherein the waveform construction unit constructs the time waveform of the terahertz wave by extracting the detection result of the terahertz wave detection unit based on a detection result of the optical detection unit.

Further aspects of the present invention will become apparent from the following description of exemplary embodiments with reference to the attached drawings.

### BRIEF DESCRIPTION OF THE DRAWINGS

FIG. 1 is a schematic configuration diagram of an information obtaining apparatus.

FIG. 2 is an explanatory diagram for describing a configuration of an information obtaining apparatus according to an example 1.

FIG. 3 is an explanatory diagram for describing a modified example of a retardation optical unit according to the example 1.

FIG. 4 is an explanatory diagram for describing a modified example of an interval monitoring unit according to the example 1.

FIG. 5 is an explanatory diagram for describing a configuration of an information obtaining apparatus according to an example 2.

FIG. 6A illustrates an example configuration of an obtaining unit using a fiber measurement system.

FIG. 6B illustrates an example configuration of an obtaining unit using a spatial measurement system.

FIG. 7A is an explanatory diagram for describing a modified example of the retardation optical unit according to the example 1.

FIG. 7B is a cross sectional view as seen from VIIB-VIIB of FIG. 7A, illustrating the modified example of the retardation optical unit according to the example 1.

FIG. 8 is a flow chart illustrating a method of constructing a time waveform.

FIG. 9 is a flow chart illustrating another method of constructing the time waveform.

### DESCRIPTION OF THE EMBODIMENTS

### Exemplary Embodiment

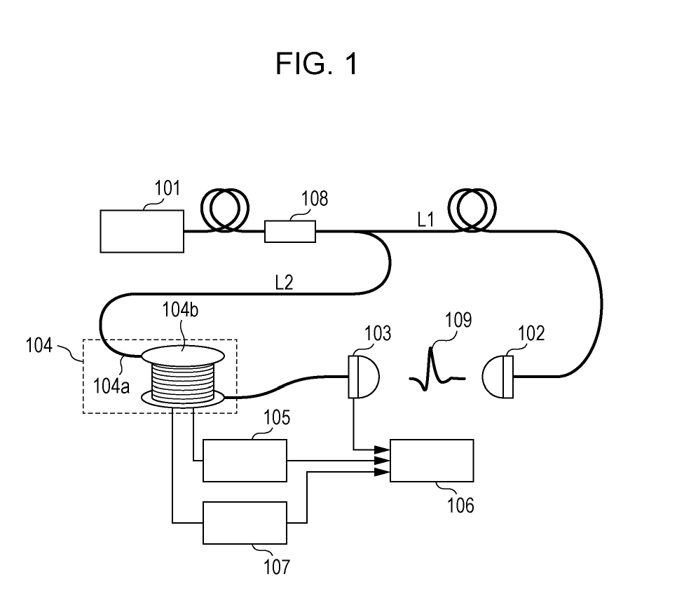

An information obtaining apparatus according to the present embodiment will be described with reference to FIG. 1. FIG. 1 is a configuration diagram of the information obtaining apparatus. The information obtaining apparatus according to the present embodiment is a THz-TDS apparatus using a fiber-type retardation optical unit. It is noted that a term “fiber” mentioned in the present specification is an optical waveguide for propagating light while the light is confined by using a refractive index distribution.

The information obtaining apparatus includes a light source 101, a terahertz wave generation unit 102 (hereinafter, referred to as “generation unit 102”), a terahertz wave detection unit 103 (hereinafter, referred to as “detection unit 103”), a retardation optical unit 104, an interval monitoring unit 105, a waveform construction unit 106, an obtaining unit 107, and a splitting unit 108. The information obtaining apparatus includes a computer provided with a CPU, a memory, a storage device, and the like, and the computer has a function of the waveform construction unit 106.

The light source 101 outputs ultrashort pulse light. Herein, the ultrashort pulse light refers to pulse light having a pulse width in a femtosecond order. Typically, the light source 101 is a femtosecond laser having a pulse width that is larger than or equal to 10 femtoseconds and smaller than or equal to 100 femtoseconds and a repetitive frequency of 10 MHz.

The ultrashort pulse light (pulse light) output from the light source 101 is split into pump light L1 for generating a terahertz wave 109 at the splitting unit 108 and probe light L2 for detecting the terahertz wave 109. The splitting unit 108 may be a unit that splits light such as a fiber coupler or a beam splitter.

The generation unit 102 is configured to generate the pulsed terahertz wave 109 upon incidence of the pump light L1. A pulse width of the generated terahertz wave 109 is typically several hundred femtoseconds to several picoseconds.

A photoconductive element in which an antenna is formed by a conductor on a semiconductor film can be applied as the generation unit 102. In addition, a generation element or the like in a mode in which a semiconductor substrate or a surface of an organic crystal is irradiated with the pump light L1 or a mode in which the pump light L1 is guided to nonlinear crystal can be applied as the generation unit 102. It is possible to apply a related art technology with which this purpose can be realized to the generation unit 102 so long as the pulsed terahertz wave 109 is generated by the input of the pump light L1.

The detection unit 103 is configured to detect the terahertz wave 109 by the incidence of the probe light L2. In detail, the detection unit 103 detects an instantaneous value of an electric field intensity of the terahertz wave 109 that reaches upon the incidence of the probe light L2. For example, a sample (not illustrated) is irradiated with the terahertz wave 109 generated in the generation unit 102, and the terahertz wave 109 that has transmitted through the sample or has been reflected by the sample is detected by the detection unit 103. A detail description related to a method of irradiating the sample (not illustrated) with the terahertz wave 109 will be omitted.

A technique of detecting an electric field by using the above-described photoconductive element or an electro-optical effect or a technique of detecting a magnetic field by using a magneto-optical effect can be applied to the detection unit 103. It is sufficient if the detection unit 103 can detect the terahertz wave 109 by using the probe light L2, and it is possible to apply a related art technology with which this purpose can be realized to the detection unit 103.

The retardation optical unit 104 is a fiber-type retardation optical unit configured to adjust an optical path length difference between the pump light L1 that reaches the generation unit 102 and the probe light L2 that reaches the detection unit 103. The retardation optical unit 104 according to the present embodiment is constituted by a fiber 104a through which the probe light L2 propagates and a changing unit 104b configured to change an optical path length of the fiber 104a. In detail, the changing unit 104b changes a length of the fiber 104a or a physical property such as a refractive index to change the optical path length of the fiber 104a.

It is noted that the “length of the fiber 104a” mentioned in the present specification refers to the physical length of the fiber 104a instead of an optical length (optical path length) of the fiber 104a.

The interval monitoring unit 105 is configured to monitor an optical path length difference between an optical path length of the pump light L1 and an optical path length of the probe light L2 such that an interval at which the detection unit 103 detects the terahertz wave 109, that is, a time difference between data pieces of instantaneous values of the adjacent terahertz waves 109 becomes constant. Since the optical path length of the fiber is changed due to a change in a surrounding environment, the elasticity modulus of the fiber itself, or the like, the interval at which the detection unit 103 detects the terahertz wave 109 may not be constant in some cases. In view of the above, the interval monitoring unit 105 monitors a propagation distance of the probe light L2 such that the interval for detecting the terahertz wave 109 becomes constant by using the configuration described in Non-patent document 1 and outputs a detection trigger.

The interval monitoring unit 105 is not limited to the configuration in which a digital signal such as the detection trigger is output, and the interval monitoring unit 105 may output an analog signal such as a variation of the length of the fiber 104a. The configuration of the interval monitoring unit 105 will be described in the following respective examples.

The waveform construction unit 106 is configured to construct a time waveform of the terahertz wave 109 by using a detection result of the detection unit 103. Data used for the construction of the time waveform of the terahertz wave 109 includes electric field intensities of a plurality of terahertz waves 109 detected at different timings.

The obtaining unit 107 is configured to obtain information related to an optical path length of the fiber 104a. The information related to the optical path length of the fiber 104a includes an intensity of interfering light of the light that has propagated through the fiber 104a and the light that has not propagated through the fiber 104a, the variation of the changing unit 104b, or the like. The information obtaining apparatus sets a measurement reference of the time axis constructed by the waveform construction unit 106 based on the information related to the optical path length of the fiber 104a, and as a result, suppresses a variation of the position on the time axis of the time waveform of the terahertz wave 109.

Specifically, the detection unit 103 starts the detection of the terahertz wave 109 based on the information related to the optical path length of the fiber 104a. Alternatively, the waveform construction unit 106 extracts the detection result of the detection unit 103 and constructs the time waveform based on the information related to the optical path length of the fiber 104a.

A method of suppressing the variation of the position on the time axis of the time waveform of the terahertz wave 109 by using the information related to the optical path length of the fiber 104a will be described in detail. The configuration of the obtaining unit 107 will be described in detail in the following respective examples.

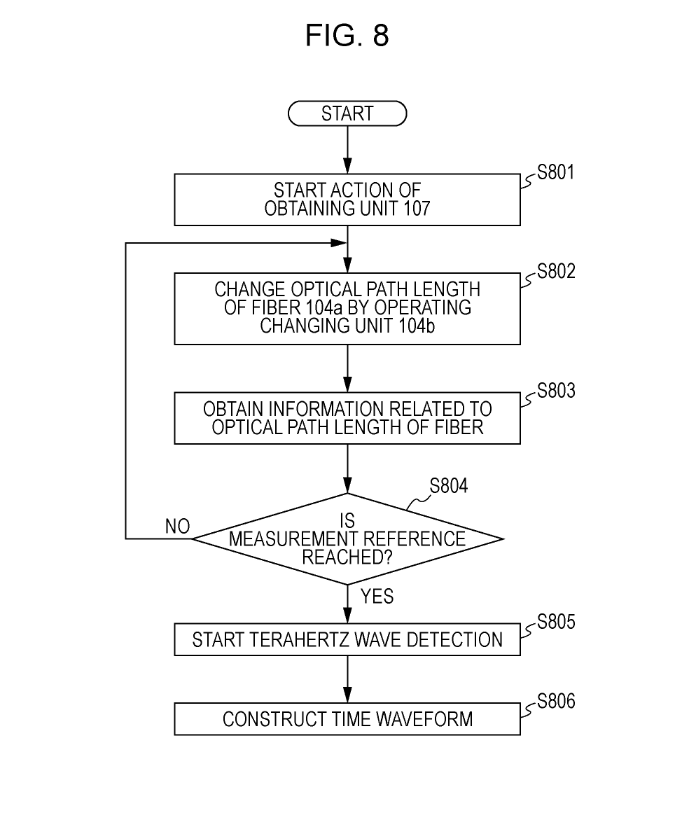

First, a method for the detection unit 103 to start the detection of the terahertz wave 109 based on the information related to the optical path length of the fiber 104a will be described with reference to FIG. 8. According to this method, the information related to the optical path length of the fiber 104a is obtained while the optical path length is changed by the changing unit 104b, and a reference (measurement reference) for starting the measurement is identified based on the information. Subsequently, the detection unit 103 starts the detection of the terahertz wave 109 from the measurement reference.

A specific example action flow will be described with reference to FIG. 8. FIG. 8 is a flow chart representing an action of the information obtaining apparatus.

When the action of the information obtaining apparatus is started, the obtaining unit 107 starts to obtain the information related to the optical path length of the fiber 104a (S801). Thereafter, the changing unit 104b starts the action and changes the optical path length difference by changing the optical path length of the fiber 104a (S802). S801 and S802 may be performed at the same time, and also the order of S801 and S802 may be reversed.

The obtaining unit 107 obtains the information related to the optical path length of the fiber 104a each time the optical path length difference is changed while the changing unit 104b is operated (S803). Thereafter, the waveform construction unit 106 determines whether or not the measurement reference is reached from the obtained information related to the optical path length of the fiber 104a (S804). In a case where the measurement reference is not reached, the changing unit 104b is operated again to change the optical path length difference, and the action from S802 to S804 is repeatedly performed until the measurement reference is reached. The detection unit 103 starts the detection of the terahertz wave 109 from a time when the measurement reference is reached (S805).

According to the present embodiment, the detection unit 103 starts the detection from the measurement reference. However, the present invention is not limited to the configuration. For example, the detection unit 103 may start the detection after a predetermined time elapses from the measurement reference.

When the terahertz wave 109 is detected and the measurement for the time waveform is completed, the waveform construction unit 106 constructs the time waveform of the terahertz wave 109 by using all or a part of the detection results (S806). Even in a case where the time waveform is constructed by using a range where the measurement reference is not included among the detection results, since the position on the time axis can be identified based on the measurement reference, it is possible to suppress the variation of the position on the time axis of the time waveform. As a result, the process of extracting the time waveform having the high appearance probability by performing the measurement for the time waveform plural times can be shortened, and it is possible to reduce the time to obtain the time waveform.

In addition, according to this measurement method, the measurement for the time waveform of the terahertz wave 109 is started after the measurement reference is reached. For that reason, since the necessary minimum amount of data used for the construction of the time waveform is obtained, it is possible to reduce the amount of data to be dealt with.

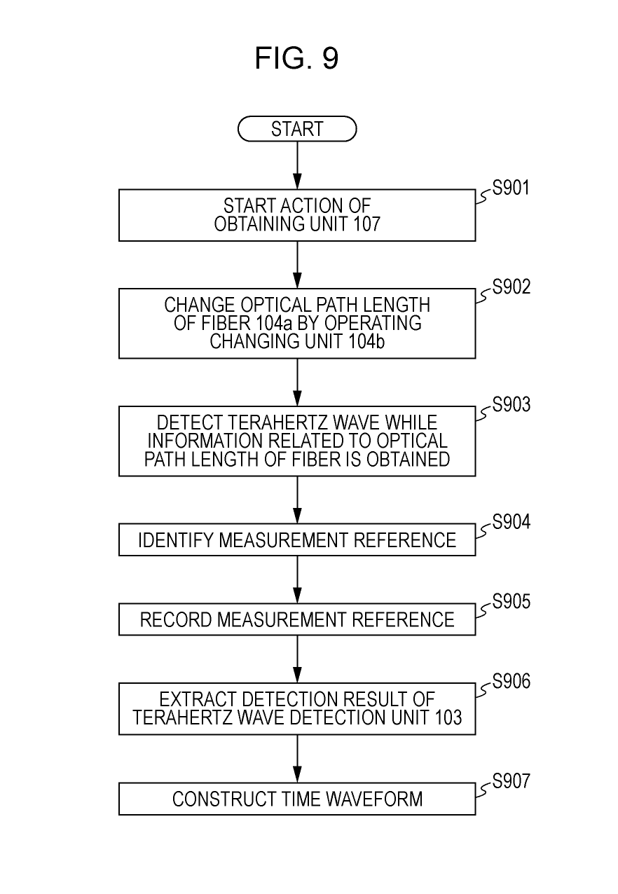

Next, a method for the waveform construction unit 106 to extract the detection result of the detection unit 103 and construct the time waveform based on the information related to the optical path length of the fiber 104a will be described with reference to FIG. 9. FIG. 9 is a flow chart representing the action of the information obtaining apparatus. According to this method, when the changing unit 104b is operated, the detection unit 103 also starts the detection of the terahertz wave 109. Thereafter, the waveform construction unit 106 extracts the data used for the construction of the time waveform from the detection result of the detection unit 103.

According to this method too, similarly as in the above-described method, the information related to the optical path length of the fiber 104a is obtained while the optical path length is changed by the changing unit 104b, and a reference (measurement reference) for extracting the detection result is identified based on the information. Then, the detection unit 103 extracts data at and after the measurement reference.

When the action of the information obtaining apparatus is started, the obtaining unit 107 starts the action (S901). Thereafter, the changing unit 104b starts the action to change and the optical path length of the fiber 104a (S902). S901 and S902 may be performed at the same time, and also the order of S901 and S902 may be reversed.

The detection unit 103 detects the terahertz wave 109 along with the action of changing the optical path length of the fiber 104a by the changing unit 104b (S903). Specifically, the detection unit 103 detects the terahertz wave 109 along with the action of the changing unit 104b, and also the obtaining unit 107 obtains the information related to the optical path length of the fiber 104a.

After the action of the changing unit 104b is confirmed, the detection unit 103 is configured to start the detection of the terahertz wave 109. The configuration is not limited to this, and the detection unit 103 may take a configuration in which after the changing unit 104b starts the action, the detection is started when the changing unit 104b changes by a predetermined optical path length difference, a configuration in which the detection is started when the changing unit 104b passes through a sensor, or the like. The detection result of the detection unit 103 is recorded in a recording unit (not illustrated). The recording unit is a memory provided to a computer, an external storage apparatus such as a hard disc, or the like.

The measurement reference for identifying a range of the data used for the construction of the time waveform is identified from the obtained information related to the optical path length of the fiber 104a in parallel with the detection of the terahertz wave 109 (S904). When the measurement reference is identified, the measurement reference is recorded in the recording unit (S905).

In a case where the measurement reference is recorded, a column number of a data line in which the detection result is recorded may be recorded, or data converted into the optical path length of the fiber 104a at the measurement reference, the optical path length difference between the pump light L1 and the probe light L2, or the like may be recorded. That is, any format of data to be stored may be employed so long as a started column of the data used for the construction of the time waveform can be found by referring to the measurement reference.

When the measurement of the terahertz wave 109 is completed, the waveform construction unit 106 extracts data including the detection result used for the construction of the time waveform of the terahertz wave 109 by using the measurement reference as a reference (S906). According to the present embodiment, the data used for the construction of the time waveform is extracted while the detection result of the measurement reference is set as the starting column. It is noted that the present invention is not limited to the above-described configuration. For example, the data used for the construction of the time waveform may be extracted while a detection result at a time when a predetermined time elapses from the measurement reference is set as the starting column.

The waveform construction unit 106 constructs the time waveform of the terahertz wave 109 by using all the detection results included in the extracted data or a part of the detection results (S907). Even in a case where the detection results corresponding to the part of the extracted data are used, while the detection result at the measurement reference is set as the reference, the variation of the position on the time axis of the time waveform of the terahertz wave 109 is suppressed, and it is possible to reduce the time to construct the time waveform.

According to this measurement method, after the terahertz wave 109 is measured so as to include the detection result used for the construction of the time waveform, the measurement reference is identified by referring to the information related to the optical path length of the fiber 104a, and the data used for the construction of the time waveform is extracted. For that reason, it is possible to omit the process for checking whether or not the measurement reference is reached each time the optical path length difference is changed in the course in which the measurement of the terahertz wave 109 is performed, and the measurement at a higher speed can be carried out, so that it is possible to reduce the time to obtain the time waveform.

The time waveform of the terahertz wave 109 which is obtained by the above-described method includes the information of the sample irradiated with the terahertz wave 109, and the information of the sample can be obtained by examining the time waveform.

For example, the time waveform of the terahertz wave 109 that has transmitted through the sample turns to have a time waveform that reflects the physical properties of the sample, and therefore optical characteristics of an object to be measured can be found by analyzing this time waveform. In a case where the terahertz wave 109 that has been reflected by the sample is measured, optical characteristics and the like of a refractive index interface provided to the object to be measured can be found from this time waveform. The “optical characteristics” mentioned in the present specification is defined to include a complex amplitude reflectivity, a complex refractive index, a complex permittivity, a reflectivity, a refractive index of, an absorption coefficient, a permittivity, an electrical conductivity, and the like of a test body.

When the configuration further includes a position changing unit configured to change a relative position between the sample and an irradiation spot of the terahertz wave 109, this configuration can also be applied to an imaging apparatus that can obtain a transmission image, a reflection image, or the like that reflects the optical characteristics of the sample. At this time, from a position of an interface, a distribution of the optical characteristics, or the like, a shape of an object in the test body, a shape of an area having predetermined optical characteristics in the test body, or the like can be obtained as the information of the sample.

The outline of the information obtaining apparatus has been described above. Hereinafter, the information obtaining apparatus will also be described more specifically by way of examples. It is noted that descriptions on the same parts as those in the above explanations will be omitted.

### EXAMPLE 1

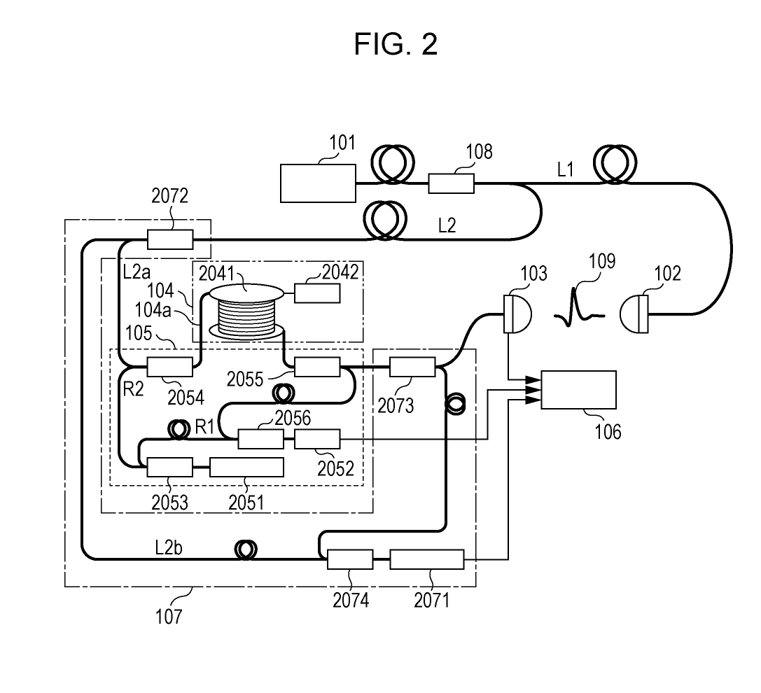

FIG. 2 is an apparatus configuration diagram for describing an information obtaining apparatus according to an example 1. According to the present example, example configurations of the retardation optical unit 104, the interval monitoring unit 105, and the obtaining unit 107 will be described.

The fiber-type retardation optical unit 104 according to the present example is constituted by the fiber 104a through which the probe light L2 split from the ultrashort pulse light (pulse light) which is output from the light source 101 propagates, and the changing unit 104b. The changing unit 104b is provided with an expansion and contraction unit 2041 and a driver unit 2042.

The expansion and contraction unit 2041 is a bobbin-type piezoelectric element. The fiber 104a is adhered and immobilized in a state of being wound around the expansion and contraction unit 2041, and the fiber 104a is expanded and contracted since the expansion and contraction unit 2041 is deformed. The driver unit 2042 is a controller that applies the piezoelectric element with a voltage for deforming the piezoelectric element of the expansion and contraction unit 2041. The length of the fiber 104a is changed along with the deformation of the expansion and contraction unit 2041, and accordingly the optical path length of the fiber 104a is changed. Since the optical path length of the pump light L1 that reaches the generation unit 102 is not changed, it is possible to adjust the optical path length difference between the pump light L1 and the probe light L2 by the retardation optical unit 104.

For example, polarization retaining fiber is used as the fiber 104a, and in a case where the fiber 104a having a length of 60 m is wound around the expansion and contraction unit 2041, the fiber 104a expands and contracts at a rate of approximately 5.5 um/V with respect to the voltage of the driver unit 2042. When the driver unit 2042 controls the expansion and contraction unit 2041 by the voltage of ±400 V at 300 Hz, it is possible to adjust the optical path length difference in a range of approximately 20 picoseconds.

It is noted that the range of the adjustment of the optical path length difference is changed depending on a type and a length of used fiber and an applied voltage of the driver unit 2042. Similarly as in Non-patent document 1, it is also possible to adjust the optical path length difference exceeding 100 picoseconds by adjusting the type of the fiber and a condition of the applied voltage.

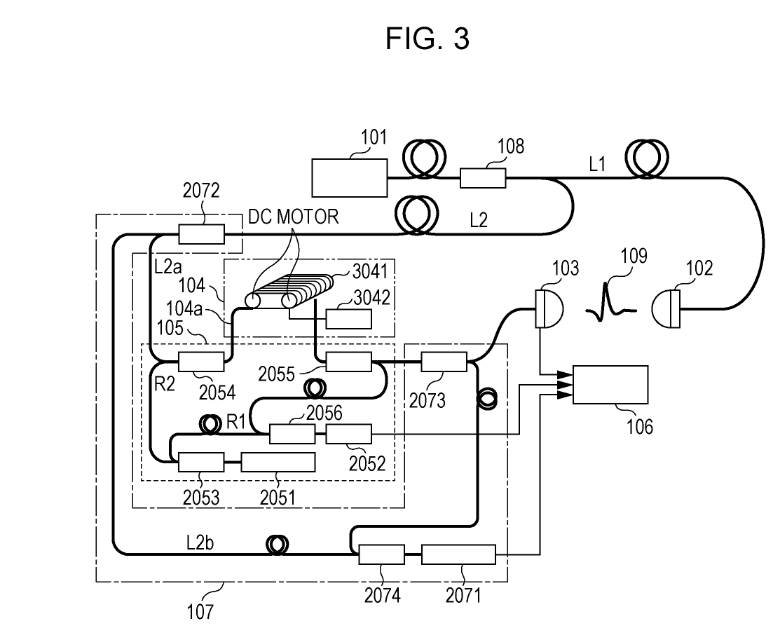

As another configuration of the fiber-type retardation optical unit 104, a configuration illustrated in FIG. 3 can also be used. In FIG. 3, the retardation optical unit 104 includes the changing unit 104b provided with an expansion and contraction unit 3041 and a driver unit 3042, and the fiber 104a.

The expansion and contraction unit 3041 is configured to change the length of the fiber 104a. In detail, the fiber 104a is wound around the expansion and contraction unit 3041 in which DC motors are arranged in parallel, and the fiber 104a is reeled by rotations of the DC motors in the expansion and contraction unit 3041, so that the optical path length of the fiber 104a is changed. The type of the motor is not limited to the DC motor, and a stepper motor or the like may be used. In addition, the number of motors is not limited to two. The driver unit 3042 is a controller configured to control the motors.

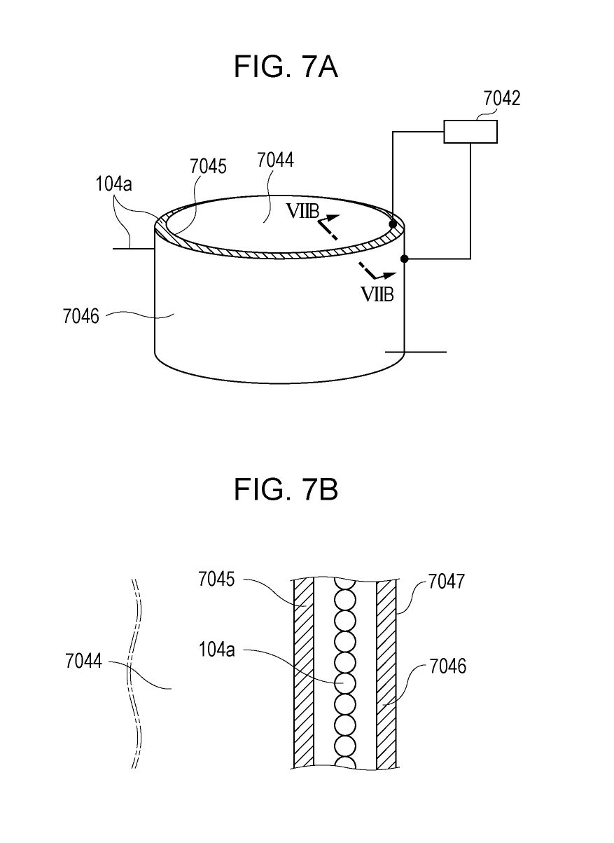

The method of adjusting the optical path length of the fiber 104a by using the changing unit 104b is not limited to the method of changing the length of the fiber 104a. For example, the optical path length can be adjusted by changing a refractive index of the fiber 104a. This example will be illustrated in FIG. 7A and FIG. 7B. FIG. 7A is an explanatory diagram for describing a retardation optical unit 7040 according to a modified example of the retardation optical unit 104, and FIG. 7B is a cross sectional view as seen from VIIB-VIIB of FIG. 7A.

The retardation optical unit 7040 of FIG. 7A includes a first electrode 7045 and a second electrode 7046 provided to a bobbin-type member 7044, the changing unit 104b including a driver unit 7042, and the fiber 104a having an electro-optical effect.

As illustrated in FIG. 7B, the fiber 104a is located between the first electrode 7045 and the second electrode 7046 and immobilized in a state of being wound around the member 7044 by an insulating part 7047. The insulating part 7047 has a role of immobilizing and protecting the fiber 104a.

The first electrode 7045 and the second electrode 7046 are electrodes that apply an electric field to the fiber 104a and formed in a concentric fashion to sandwich the fiber 104a on an outer side of the member 7044. The driver unit 7042 is configured to apply an electric field to the first electrode 7045 and the second electrode 7046.

According to this configuration, the adjustment of the optical path length of the fiber 104a in the retardation optical unit 104 can be performed by the external electric field. For that reason, the optical path length of the fiber 104a can be electrically adjusted, and an improvement in the measurement speed of the terahertz wave 109 can be expected as compared with a mechanical adjustment.

The interval monitoring unit 105 is constituted by an interference optical system. The fundamental configuration is the same as a technology of Mach-Zehnder interference system incorporated in a retardation optical unit in Non-patent document 1. In detail, the interval monitoring unit 105 includes a reference light source 2051, an optical detector 2052, splitting units 2053 and 2055, and merging sections 2054 and 2056. The merging section 2054 and the splitting unit 2055 use a wavelength division multiplexing coupler (hereinafter, referred to as WDM coupler). The merging section 2056 and the splitting unit 2053 are constituted by a coupler.

The interval monitoring unit 105 detects the interfering light of the light that has propagated through the fiber 104a and the light that has not propagated through the fiber 104a out of the light from the reference light source 2051 and as a result, detects a relative optical path length difference between the pump light L1 and the probe light L2.

The reference light source 2051 outputs a continuous wave. Hereinafter, the continuous wave output by the reference light source 2051 will be referred to as reference light. The reference light is input to the splitting unit 2053 and split by two into reference light R1 and reference light R2. The reference light R2 is input to the merging section 2054, and the reference light R1 is input to the merging section 2056.

In addition to the reference light R2, first light L2a split from the probe light L2 before reaching the retardation optical unit 104 is input to the merging section 2054. An output of the merging section 2054 is input to the retardation optical unit 104. A wavelength of the first light L2a is preferably different from a wavelength of the reference light R2 so as to avoid unwanted interference. The first light L2a and the reference light R2 are output from the merging section 2054 and propagate through the fiber 104a of the retardation optical unit 104.

The first light L2a and the reference light R2 that have propagated through the fiber 104a are input to the splitting unit 2055 to be split by two. The reference light R2 from the splitting unit 2055 is input to the merging section 2056, and the first light L2a is input to a splitting unit 2073 of the obtaining unit 107 which will be described below.

The reference light R2 that has propagated through a route via the retardation optical unit 104 and the reference light R1 that has not propagated through the route via the retardation optical unit 104 are input to the merging section 2056. For that reason, a phase difference is caused between the reference light R1 and the reference light R2, and interference occurs in the merging section 2056. In detail, an intensity of the interfering light output by the merging section 2056 is changed in accordance with the optical path length of the fiber 104a which is adjusted by the retardation optical unit 104.

The optical detector 2052 detects an intensity of the interfering light output from the merging section 2056 and outputs a signal (interfering signal). When strength and weakness patterns of this interfering signal are counted, it is possible to read the change in the optical path length difference between the pump light L1 and the probe light L2. For example, laser having a wavelength of 1310 nm is used as the reference light source 2051, and when a refractive index of fiber 2043 is assumed to be 1.5, strength and weakness of the interfering wave are repeated every approximately 3 femtoseconds. A change in the relative optical path length of the probe light L2 with respect to the pump light L1 is detected by counting these strength and weakness patterns.

The output of the optical detector 2052 is input to the waveform construction unit 106. The waveform construction unit 106 refers to the output of the optical detector 2052 and decides on an interval for recording the detection result of the detection unit 103. For example, a configuration in which the optical detector 2052 outputs the detection trigger every strength and weakness pattern, and when the waveform construction unit 106 obtains the detection trigger from the optical detector 2052, an instantaneous value of the detection unit 103 is recoded may be used, but the present invention is not limited to this configuration.

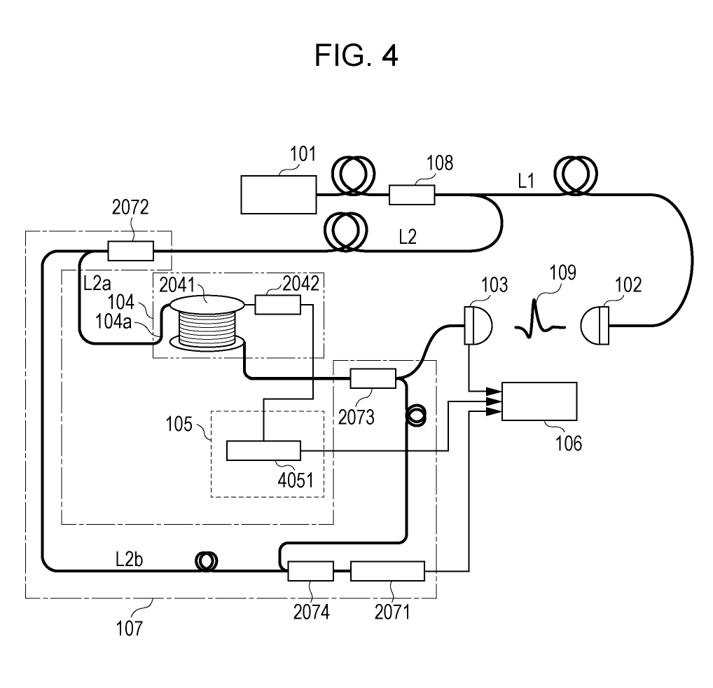

In addition, the interval monitoring unit 105 may use a signal used for driving the retardation optical unit 104 without using the reference light. For example, according to the configuration of FIG. 4, the interval monitoring unit 105 includes a position conversion unit 4051 configured to refer to a control signal from the driver unit 2042 for adjusting a deformation manner of the expansion and contraction unit 2041 and convert this control signal to a position on the time axis of the time waveform. The position conversion unit 4051 stores a change in a propagation distance of the first light L2a with respect to the control signal output by the driver unit 2042 or the like in advance and obtains the position on the time axis from the control signal by using the information to output the detection trigger.

Hereinafter, the configuration of the obtaining unit 107 will be described. The obtaining unit 107 according to the present example is constituted by an interference optical system. As illustrated in FIG. 2, the obtaining unit 107 includes splitting units 2072 and 2073, a formation unit 2074, and an optical detection unit 2071. The splitting units 2072 and 2073 and the formation unit 2074 are constituted by a coupler.

A part of the pulse light output from the light source 101 is split by the splitting unit 108 into the pump light L1 and the probe light L2. Thereafter, the probe light L2 is input to the splitting unit 2072 and split into the first light L2a and second light L2b. The second light L2b is directly input to the formation unit 2074. The first light L2a is input to the merging section 2054 constituting the interval monitoring unit 105 described above. The first light L2a input to the merging section 2054 is input to the splitting unit 2073 via the retardation optical unit 104 and the splitting unit 2055.

The splitting unit 2073 further splits the first light L2a that has propagated through the fiber 104a by two. One split light is input to the detection unit 103 as the probe light and used for the detection of the terahertz wave 109. The other split light is input to the formation unit 2074.

The light that has propagated through a route via the retardation optical unit 104 (part of the first light L2a) and the light that has propagated through a route without the intermediation of the retardation optical unit 104 (the second light L2b) are input to the formation unit 2074, and interfering light thereof is formed. According to the present specification, the interfering light of the part of the first light L2a and the second light L2b is regarded as interfering light of the first light L2a and the second light L2b.

The optical detection unit 2071 is configured to detect the intensity of the interfering light formed by the formation unit 2074. The optical detection unit 2071 according to the present example detects the intensity of the interfering light as the information related to the optical path length of the fiber 104a. A situation where the intensity of the interfering light becomes the highest is set as the measurement reference.

The intensity of the interfering light output from the formation unit 2074 is changed in accordance with the optical path length of the first light L2a changed by the retardation optical unit 104. Specifically, when the part of the first light L2a and the second light L2b are input to the formation unit 2074 at the same time, the intensity of the interfering light becomes the highest. According to the present example, the measurement reference is identified by using the change in the intensity of the interfering light.

When the measurement reference is identified, the optical detection unit 2071 outputs a digital signal such as a trigger indicating the measurement reference (hereinafter, referred to as measurement reference trigger) or continuously outputs a detection result of the optical detection unit 2071 as an analog signal. In a case where the analog signal is output, a value corresponding to the measurement reference (measurement reference value) is set in advance, and the waveform construction unit 106 includes a system configured to compare this measurement reference value with information related to the optical path length of the fiber.

Since the light input to the formation unit 2074 is the ultrashort pulse light in general, the change in the intensity of the interfering light is relatively smaller than the intensity of the input light. To detect this intensity change at a satisfactory sensitivity, the optical detection unit 2071 preferably takes a mode in which the intensity signals of the pulse light steadily detected from the interfering light are removed, and only the intensity change is detected. For example, to determine the position of the measurement reference at a satisfactory sensitivity, the difference of the intensity change is preferably increased by using a nonlinear effect.

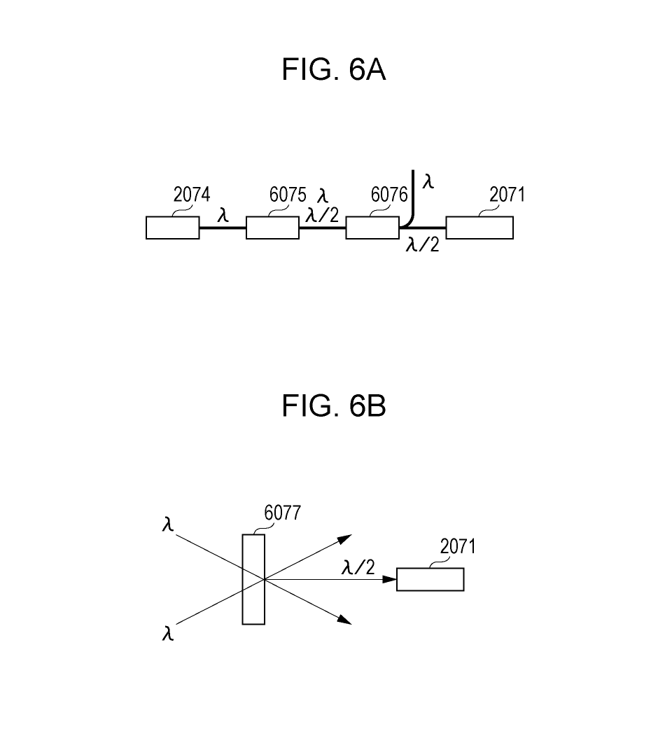

An example method of improving the detection sensitivity for the optical detection unit 2071 by using the nonlinear effect will be described. FIG. 6A illustrates an example of the configuration of the obtaining unit 107 using a fiber measurement system.

In the example where the fiber measurement system illustrated in FIG. 6A is used, the interfering light output from the formation unit 2074 is input to the optical detection unit 2071 via nonlinear crystal fiber 6075 and a dividing unit 6076. The formation unit 2074 is constituted by a counter. The dividing unit 6076 is constituted by a WDM coupler.

Herein, a wavelength of the interfering light from the formation unit 2074 is set as λ. The wavelength λ of the interfering light is a wavelength of the pulse light output by the light source 101. When the interfering light propagates through the nonlinear crystal fiber 6075, a fundamental wave λ and a higher harmonic wave λ/2 are generated by the nonlinear effect, and the fundamental wave λ and the higher harmonic wave λ/2 are divided from each other by the dividing unit 6076. Thereafter, the optical detection unit 2071 detects the higher harmonic wave λ/2, so that the intensity of the interfering light is obtained.

In this manner, when the higher harmonic wave is detected by removing the fundamental wave of the interfering light by using the nonlinear crystal fiber 6075, the sensitivity of the optical detection unit 2071 is increased, and it is possible to obtain the measurement reference at a satisfactory accuracy. In addition, since the obtaining unit 107 can be all constituted by the fiber, downsizing of the apparatus is facilitated.

FIG. 6B illustrates an example of the configuration of the obtaining unit 107 for improving the detection sensitivity of the optical detection unit 2071 by using the nonlinear effect, corresponding to an example configuration using a spatial measurement system where fiber is not used. In a case where the spatial measurement system is used for the obtaining unit 107, and the formation unit 2074 is formed by nonlinear crystal 6077. In detail, the part of the first light L2a and the second light L2b are adjusted to be incident at angles where the nonlinear effect occurs with respect to the nonlinear crystal 6077, and an interfering wave of the higher harmonic waves λ/2 of the respective pulse lights is detected as the interfering light by the optical detection unit 2071.

When the spatial measurement system is used, since propagation paths of the higher harmonic wave λ/2 and the fundamental wave λ are spatially separated from each other, the signals of the higher harmonic waves λ/2 are easily taken out. In addition, the ultrashort pulse light propagates through the open space, and the pulse shape and the quality such power of the ultrashort pulse light are easily maintained, so that it is possible to obtain the measurement reference at a satisfactory accuracy. With the above-described configuration, the information obtaining apparatus according to the present example can shorten the time to obtain the time waveform than the time required in the related art.

It is noted that in a case where the retardation optical unit 104, the interval monitoring unit 105, and the obtaining unit 107 are constructed by a fiber system, characteristics of the fiber may be changed by an external environment such as a temperature or a moisture. To suppress the change in the characteristics of the fiber, a temperature adjusting mechanism is preferably provided at least to these units. Alternatively, a temperature adjusting mechanism that performs temperature adjustment on the entirety of the information obtaining apparatus may be provided.

### EXAMPLE 2

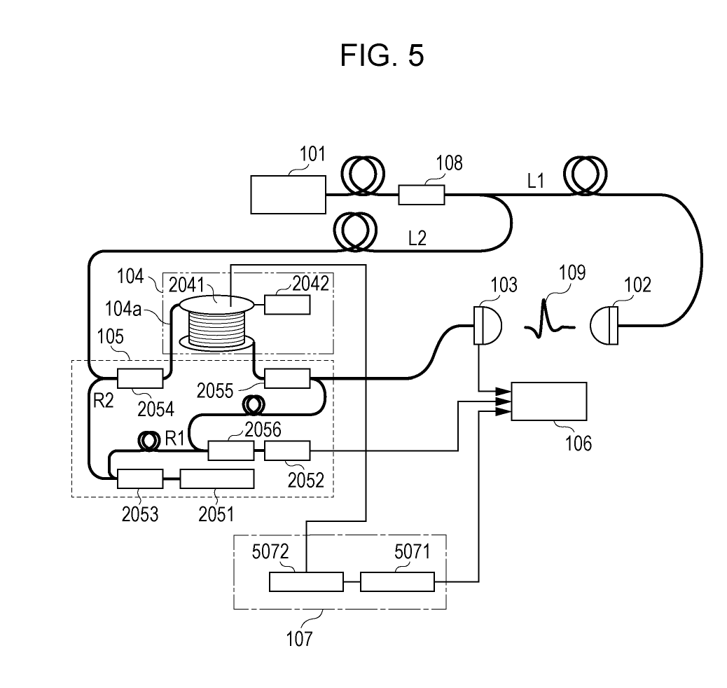

An example 2 will be described with reference to FIG. 5. It is noted that descriptions of the same parts as those according to the above-described example 1 will be omitted. FIG. 5 illustrates a configuration of an information obtaining apparatus according to the present example.

The information obtaining apparatus according to the present example is different from the example 1 the configuration of the obtaining unit 107. Specifically, according to the example 1, the obtaining unit 107 uses the interference optical system to detect the intensity of the interfering light of the second light L2b where the optical path length is constant and the first light L2a that has propagated through the fiber 104a where the optical path length is changed and sets the intensity as the information related to the optical path length of the fiber. In contrast to this, according to the present example, a physical variation of the changing unit 104b is obtained as the information related to the optical path length of the fiber. The components other than the configuration of the obtaining unit 107 are the same as those according to illustrated in FIG. 2.

In FIG. 5, the obtaining unit 107 is constituted by an encoder 5072 functioning as a measurement unit configured to measure the physical variation of the expansion and contraction unit 2041 that changes the length of the fiber 2043 by expansion and contraction and a measurement reference output unit 5071. In a case where the fiber is expanded and contracted by deforming the piezoelectric element constituting the expansion and contraction unit 2041 in a depth direction, the variation indicating how much the piezoelectric element is deformed in the depth direction is measured by the encoder 5072.

The measurement reference output unit 5071 compares the measured variation with the measurement reference value to identify the measurement reference. With regard to the measurement reference value, the value indicated by the encoder 5072 in the measurement reference is measured in advance, and it is sufficient that the value may be recorded. When the measurement reference is identified, a signal indicating the measurement reference is output.

According to the present example, the obtaining unit 107 measures the variation of the expansion and contraction unit 2041 that changes the length of the fiber 104a and obtains the variation corresponding to the measurement result as the information related to the optical path length of the fiber 104a. Since the obtaining unit 107 obtains the measurement reference by using the obtained information related to the optical path length of the fiber 104a, the information obtaining apparatus according to the present example can further shorten the time to obtain the time waveform.

The variation of the expansion and contraction unit 2041 is measured by the encoder, and it is therefore possible to electrically treat the variation. For that reason, application of a signal processing technique in a related art is facilitated, and an SN ratio of the signal is improved, so that it is possible to identify the measurement reference at a satisfactory accuracy. In addition, since the variety of constitution parts is also abundant, wide choices for constitution elements constituting the obtaining unit 107 are available, and it is possible to provide a down-sized information processing assembly inexpensively.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, according to the above-described exemplary embodiment, the retardation optical unit 104 is provided in the propagation path of the probe light corresponding to the pulse light for the detection but may be provided in the propagation path of the pump light corresponding to the pulse light for the generation. At this time, the interval monitoring unit 105 and the obtaining unit 107 are also provided on the pump light side.

Moreover, according to the above-described exemplary embodiment, the propagation path of the pulse light is constituted by the fiber, but the configuration is not limited to this. Fiber except for the fiber 104a constituting the retardation optical unit 104 can be replaced by another optical system. For example, according to the above-described exemplary embodiment, both the pump light and the probe light are set to propagate through the fiber, but the propagation path of the pump light without the intermediation of the retardation optical unit 104 may be constituted by a spatial optical system.

This application claims the benefit of Japanese Patent Application No. 2013-189445, filed Sep. 12, 2013, which is hereby incorporated by reference herein in its entirety.

What is claimed is:

1. An information obtaining apparatus that irradiates a sample with a terahertz wave and obtains information of the sample, the information obtaining apparatus comprising:
a splitting unit that splits pulse light from a light source into pump light and probe light;
a terahertz wave generation unit configured to generate a terahertz wave upon incidence of the pump light;
a terahertz wave detection unit configured to detect the terahertz wave from the sample upon incidence of the probe light;
a fiber through which the pump light or the probe light propagates;
a changing unit configured to change an optical path length difference between an optical path length of the pump light and an optical path length of the probe light by changing an optical path length of the fiber;
a waveform construction unit configured to construct a time waveform of the terahertz wave by using a detection result of the terahertz wave detection unit; and
an obtaining unit configured to obtain information related to the optical path length of the fiber,
wherein the obtaining unit includes
a splitting unit that splits the pump light or the probe light before propagating through the fiber into first light and second light,
a formation unit configured to form interfering light of the first light that has propagated through the fiber and the second light that has not propagated through the fiber, and
an optical detection unit configured to detect an intensity of the interfering light as the information related to the optical path length of the fiber, and
wherein the waveform construction unit constructs the time waveform of the terahertz wave by extracting the detection result of the terahertz wave detection unit based on a detection result of the optical detection unit.

2. The information obtaining apparatus according to claim 1, wherein the waveform construction unit identifies a range for extracting the detection result of the terahertz wave detection unit based on the information related to the optical path length of the fiber.

3. The information obtaining apparatus according to claim 1, further comprising:
a nonlinear crystal that generates a fundamental wave and a higher harmonic wave of the interfering light; and
a dividing unit configured to divide the fundamental wave and the higher harmonic wave from each other,
wherein the optical detection unit detects the higher harmonic wave from the dividing unit.

4. The information obtaining apparatus according to claim 1,
wherein the formation unit is a nonlinear crystal provided such that the first light and the second light are incident on the nonlinear crystal at an angle at which a nonlinear effect occurs, and
wherein the optical detection unit detects interfering light of a higher harmonic wave of the first light and a higher harmonic wave of the second light from the nonlinear crystal as the interfering light.

5. The information obtaining apparatus according to claim 1, wherein the information related to the optical path length of the fiber is information used to identify a measurement reference for identifying a range of the detection result of the terahertz wave detection unit.

6. The information obtaining apparatus according to claim 1,
wherein the probe light propagates through the fiber, and
wherein the pump light propagates through another fiber different from the fiber.

7. An information obtaining apparatus that irradiates a sample with a terahertz wave and obtains information of the sample, the information obtaining apparatus comprising:
a splitting unit that splits pulse light from a light source into pump light and probe light;
a terahertz wave generation unit configured to generate a terahertz wave upon incidence of the pump light;
a terahertz wave detection unit configured to detect the terahertz wave from the sample upon incidence of the probe light;
a fiber through which the pump light or the probe light propagates;
a changing unit configured to change an optical path length difference between an optical path length of the pump light and an optical path length of the probe light by changing an optical path length of the fiber;
a waveform construction unit configured to construct a time waveform of the terahertz wave by using a detection result of the terahertz wave detection unit; and
an obtaining unit configured to obtain information related to the optical path length of the fiber,
wherein the obtaining unit includes
a splitting unit that splits the pump light or the probe light before propagating through the fiber into first light and second light,
a formation unit configured to form interfering light of the first light that has propagated through the fiber and the second light that has not propagated through the fiber, and
an optical detection unit configured to detect an intensity of the interfering light as the information related to the optical path length of the fiber, and
wherein the terahertz wave detection unit starts the terahertz wave detection based on a detection result of the optical detection unit.

8. The information obtaining apparatus according to claim 7, further comprising:
a nonlinear crystal that generates a fundamental wave and a higher harmonic wave of the interfering light; and
a dividing unit configured to divide the fundamental wave and the higher harmonic wave from each other,
wherein the optical detection unit detects the higher harmonic wave from the dividing unit.

9. The information obtaining apparatus according to claim 7,
wherein the formation unit is a nonlinear crystal provided such that the first light and the second light are incident on the nonlinear crystal at an angle at which a nonlinear effect occurs, and
wherein the optical detection unit detects interfering light of a higher harmonic wave of the first light and a higher harmonic wave of the second light from the nonlinear crystal as the interfering light.

10. The information obtaining apparatus according to claim 7, wherein the information related to the optical path length of the fiber is information used to identify a measurement reference for identifying a timing at which the terahertz wave detection unit starts the terahertz wave detection.

11. The information obtaining apparatus according to claim 7,
wherein the probe light propagates through the fiber, and
wherein the pump light propagates through another fiber different from the fiber.

12. An information obtaining apparatus that irradiates a sample with a terahertz wave and obtains information of the sample, the information obtaining apparatus comprising:
a splitting unit that splits pulse light from a light source into pump light and probe light;
a terahertz wave generation unit configured to generate a terahertz wave upon incidence of the pump light;
a terahertz wave detection unit configured to detect the terahertz wave from the sample upon incidence of the probe light;
a fiber through which the pump light or the probe light propagates;
a changing unit configured to change an optical path length difference between an optical path length of the pump light and an optical path length of the probe light by changing an optical path length of the fiber;
a waveform construction unit configured to construct a time waveform of the terahertz wave by using a detection result of the terahertz wave detection unit; and
an obtaining unit configured to obtain information related to the optical path length of the fiber,
wherein the changing unit changes the optical path length of the fiber by changing a length of the fiber through deformation,
wherein the obtaining unit includes a measurement unit configured to measure a variation caused by the deformation of the changing unit as the information related to the optical path length of the fiber, and
wherein the waveform construction unit constructs the time waveform of the terahertz wave by extracting the detection result of the terahertz wave detection unit based on a measurement result of the measurement unit.

13. The information obtaining apparatus according to claim 12, wherein the information related to the optical path length of the fiber is information used to identify a measurement reference for identifying a range of the detection result of the terahertz wave detection unit.

14. The information obtaining apparatus according to claim 12,
wherein the probe light propagates through the fiber, and
wherein the pump light propagates through another fiber different from the fiber.

15. An information obtaining apparatus that irradiates a sample with a terahertz wave and obtains information of the sample, the information obtaining apparatus comprising:
a splitting unit that splits pulse light from a light source into pump light and probe light;
a terahertz wave generation unit configured to generate a terahertz wave upon incidence of the pump light;
a terahertz wave detection unit configured to detect the terahertz wave from the sample upon incidence of the probe light;
a fiber through which the pump light or the probe light propagates;
a changing unit configured to change an optical path length difference between an optical path length of the pump light and an optical path length of the probe light by changing an optical path length of the fiber;
a waveform construction unit configured to construct a time waveform of the terahertz wave by using a detection result of the terahertz wave detection unit; and
an obtaining unit configured to obtain information related to the optical path length of the fiber,
wherein the changing unit changes the optical path length of the fiber by changing a length of the fiber through deformation,
wherein the obtaining unit includes a measurement unit configured to measure a variation caused by the deformation of the changing unit as the information related to the optical path length of the fiber, and
wherein the terahertz wave detection unit starts the terahertz wave detection based on a measurement result of the measurement unit.

16. The information obtaining apparatus according to claim 15, wherein the information related to the optical path length of the fiber is information used to identify a measurement reference for identifying a timing at which the terahertz wave detection unit starts the terahertz wave detection.

17. The information obtaining apparatus according to claim 15,
wherein the probe light propagates through the fiber, and
wherein the pump light propagates through another fiber different from the fiber.

18. An information obtaining method for an information obtaining apparatus that irradiates a sample with a terahertz wave and obtains information of the sample, the information obtaining method comprising:
splitting pulse light from a light source into pump light and probe light;
generating a terahertz wave upon incidence of the pump light;
detecting the terahertz wave from the sample upon incidence of the probe light;
changing an optical path length difference between an optical path length of the pump light and an optical path length of the probe light by changing an optical path length of a fiber through which the pump light or the probe light propagates;
constructing a time waveform of the terahertz wave by using a detection result of the detecting; and
obtaining information related to the optical path length of the fiber,
wherein the obtaining includes
splitting the pump light or the probe light before propagating through the fiber into first light and second light,
forming interfering light of the first light that has propagated through the fiber and the second light that has not propagated through the fiber, and
detecting an intensity of the interfering light as the information related to the optical path length of the fiber, and
wherein the constructing includes constructing the time waveform of the terahertz wave by extracting the detection result of the detecting of the terahertz wave based on a detection result of the detecting of the intensity.

19. An information obtaining method for an information obtaining apparatus that irradiates a sample with a terahertz wave and obtaining information of the sample, the information obtaining method comprising:
splitting pulse light from a light source into pump light and probe light;
generating a terahertz wave upon incidence of the pump light;
detecting the terahertz wave from the sample upon incidence of the probe light;
changing an optical path length difference between an optical path length of the pump light and an optical path length of the probe light by changing an optical path length of a fiber through which the pump light or the probe light propagates;
constructing a time waveform of the terahertz wave by using a detection result of the detecting of the terahertz wave; and
obtaining information related to the optical path length of the fiber,
wherein the obtaining includes
splitting the pump light or the probe light before propagating through the fiber into first light and second light,
forming interfering light of the first light that has propagated through the fiber and the second light that has not propagated through the fiber, and
detecting an intensity of the interfering light as the information related to the optical path length of the fiber, and
wherein the detecting of the terahertz wave is started based on a detection result of the detecting of the intensity.

20. An information obtaining method for an information obtaining apparatus that irradiates a sample with a terahertz wave and obtaining information of the sample, the information obtaining method comprising:
splitting pulse light from a light source into pump light and probe light;
generating a terahertz wave upon incidence of the pump light;
detecting the terahertz wave from the sample upon incidence of the probe light;
changing an optical path length difference between an optical path length of the pump light and an optical path length of the probe light by changing an optical path length of a fiber through which the pump light or the probe light propagates;
constructing a time waveform of the terahertz wave by using a detection result of the detecting of the terahertz wave; and
obtaining information related to the optical path length of the fiber,
wherein the changing includes changing the optical path length of the fiber by changing a length of the fiber through deformation of a changing unit,
wherein the obtaining includes measuring a variation caused by the deformation in the changing as the information related to the optical path length of the fiber, and
wherein the constructing includes constructing the time waveform of the terahertz wave by extracting the detection result of the detecting of the terahertz wave based on a measurement result of the measuring.

21. An information obtaining method for an information obtaining apparatus that irradiates a sample with a terahertz wave and obtaining information of the sample, the information obtaining method comprising:
splitting pulse light from a light source into pump light and probe light;
generating a terahertz wave upon incidence of the pump light;
detecting the terahertz wave from the sample upon incidence of the probe light;
changing an optical path length difference between an optical path length of the pump light and an optical path length of the probe light by changing an optical path length of a fiber through which the pump light or the probe light propagates;
constructing a time waveform of the terahertz wave by using a detection result of the detecting of the terahertz wave; and
obtaining information related to the optical path length of the fiber,
wherein the changing includes changing the optical path length of the fiber by changing a length of the fiber through deformation of a changing unit,
wherein the obtaining includes measuring a variation caused by the deformation in the changing as the information related to the optical path length of the fiber, and
wherein the detection of the terahertz wave is started based on a measurement result of the measuring.
